(19) United States
(12) Patent Application Publication
(10) Pub. No.: US 2026/0152122 A1
(43) Pub. Date: Jun. 4, 2026

(54) DAZZLE PREVENTION FOR A DRIVER OF A VEHICLE AFTER A ROAD ELEVATION

(71) Applicant: Ford Global Technologies, LLC, Dearborn, MI (US)

(72) Inventors: Paul Jamnicki, Bonn (DE); Elena Feichtenbeiner, Rösrath (DE)

(73) Assignee: Ford Global Technologies, LLC, Dearborn, MI (US)

(21) Appl. No.: 19/384,145

(22) Filed: Nov. 10, 2025

(30) Foreign Application Priority Data
Nov. 28, 2024 (DE) 102024135175.6

(51) Int. Cl. B60R 1/08; B60J 3/04; B60R 1/04; B60R 1/072

(52) U.S. Cl. CPC B60R 1/083; B60J 3/04; B60R 1/04; B60R 1/072

(57) ABSTRACT

The invention describes a method to prevent a driver from being dazzled by the headlights of a following vehicle after driving over a road elevation. It involves three main steps: detecting the road elevation using the vehicle's environmental sensors, determining the exact moment when the following vehicle with a light source drives onto the elevation, and activating a device in the vehicle to prevent dazzling of the driver by the following vehicle's lights at that critical instant.

### CROSS-REFERENCE TO RELATED APPLICATIONS

The present application claims priority to and the benefit of German Application No. 102024135175.6, filed Nov. 28, 2024, which is hereby incorporated by reference herein in its entirety.

### FIELD

The invention relates to a method to prevent dazzling of a driver of a vehicle after a road elevation.

### BACKGROUND

If two vehicles are driving one after the other, for example in darkness, it occasionally happens that the driver of the preceding vehicle has the impression that the rear (following) vehicle seems to be flashing its headlights. Flashing the headlights is generally an indication that something is not right with the vehicle (i.e. the preceding vehicle) in question (for example an indication that they have forgotten to turn on the vehicle's lights), that something else about the driving behavior is wrong (for example because they are driving too slowly, or the like) or that it is a warning (for instance because they have overlooked something, for example a danger spot or the like). This unfortunately leads to the driver becoming confused when trying to find the cause of the annoying light, to the driver being distracted, to vision being impaired, and the like.

If the driver is dazzled, above all in darkness or else for drivers who are sensitive to light, their vision may be impaired for a short time after the event (in a similar way to when someone takes a photograph of a person with the camera flash turned on). This is undesirable when driving vehicles.

The problem is that the presumed headlight flashing is often caused by a following vehicle driving over a road elevation, bump or the like on the road. It is merely sufficient for the following vehicle to drive over the road elevation and for the headlamp beam (in particular its low beam) therefore to tilt upward slightly, which leads to dazzling of the driver of the preceding vehicle, in particular when they look in their mirror.

CN 111 619 324 A relates to an intelligent dazzle prevention method and system for a vehicle, in particular an intelligent accessory instrument for the windshield of the vehicle, wherein, by using a detection instrument, the accessory instrument identifies an external entity that is capable of emitting a single point of intense light and carries out a predictive adaptation according to the properties and the state of a driver's eyes. The system tracks objects that give out intense light into the visual focus and angle of vision of a driver and through the different control of the intense light that enters the driver's eyes from different directions. For this purpose, the intense light source encountered is ascertained and the transparency of the corresponding part of the windshield is adapted so that a driver's sight cannot be impaired by the intense light source encountered. In the meantime, with the aid of the currently recognized object, the system predicts the light source which may possibly give out intense light and the position of the possible light source at the next moment and performs preventive adaptations so that the driver's sight cannot be impaired by the sudden incident intense light. Implementing this method and its associated system is very expensive. Furthermore, it involves an unacceptable lack of definition in the prevention of dazzling of the driver since the system merely predicts, but does not exactly determine, the light source which may possibly give out intense light and the position of the possible light source with the aid of the currently recognized object.

DE 11 2006 002 070 T5 discloses a method for positioning an offside mirror and a nearside mirror of a vehicle, wherein the method comprises determining a current angle of the offside mirror and, on the basis of the angle, determining whether the offside mirror is in a blind spot mirror position or a blind spot/dimmed mirror position, wherein a command for switching into the other of the blind spot mirror position or the blind spot/dimmed mirror position is detected and, in response to the command, both the offside mirror and the nearside mirror are moved into the other of the blind spot mirror position or the blind spot/dimmed mirror position.

EP 2 927 780 A1 relates to a tiltable interior mirror for a vehicle, having a tilting device that is configured to move the interior mirror from a normal position into a dimmed position, wherein dazzling of a driver of the vehicle by the interior mirror is reduced in the dimmed position; and an operating device that is configured to activate the tilting device in response to a movement of the driver.

WO 2022/130 007 A1 discloses a vehicle system and an associated method for driver assistance in order to reduce reflective light interference from behind. The vehicle system comprises a plurality of dimmable mirrors, a camera which is configured to acquire images of a driver of the vehicle, and a processor which is coupled to the camera and is configured to recognize any squinting action of the driver in relation to the eye and any sudden movements of the head sideways when the squinting action of the driver is recognized. In accordance with a determination that the identification does satisfy the criteria for dimming the mirror, a dimmable mirror is dimmed based on one or more properties of the facial expressions of the driver, including a direction in which the driver's head is being turned and whether the eye is a left eye or a right eye. It has been found that for a variety of drivers of vehicles, extremely high outlay is needed in order not only to capture the very different head movements and eye areas of the driver, but also to ascertain reliably the required head movement and squinting action therefrom.

In view of the comments above, there is still scope for improvement in connection with the presented prior art in the field of methods to prevent dazzling of a driver of a vehicle after a road elevation.

### SUMMARY

The object of the invention is to provide an improved method to prevent dazzling of a driver of a vehicle after a road elevation. Dazzling of the driver of the preceding vehicle by a light source of a following vehicle is intended to be avoided when the latter drives over a road elevation.

According to the invention, the object is achieved by a method to prevent dazzling of a driver of a vehicle after a road elevation having the features of claim 1.

A method is provided to prevent dazzling of a driver of a vehicle after a road elevation, comprising at least the steps:
ascertaining a road elevation by means of environmental sensors belonging to the vehicle,
ascertaining an instant when a vehicle that is following the vehicle and has a light source, drives onto the road elevation, and
actuating a device in the vehicle to prevent dazzling of the driver of the vehicle by the light source of the following vehicle when the latter drives over the road elevation.

Advantageous embodiments are disclosed in the dependent claims.

The features and measures mentioned individually in the following description may be combined with one another in any desired technically expedient way and represent further configurations of the invention. The description additionally characterizes and specifies the invention particularly in connection with the figures.

Advantageously, the invention effectively stops dazzling the driver of the preceding vehicle by the light source of the following vehicle, when the latter drives over the road elevation, at exactly the correct instant or starting from this correct instant for a required length of time. Extreme situations of people or vehicles are avoided. At least much less or no distraction or confusion occurs for the driver of the preceding vehicle. Temporary impairment of the driver's vision due to dazzling by the light source, particularly a headlamp beam, of the following vehicle is stopped. In the context of the invention, a road elevation may be understood as any geometry on or in the road that entails the effect of dazzling the driver (for example a dip in the road and the like).

According to a further embodiment, when the following vehicle has driven over the road elevation, the device in the vehicle to prevent dazzling of the driver of the vehicle is deactivated by a second actuation. If the device is for example vision protection that can be unrolled in the region of the back window, it is unrolled by the actuation. When the following vehicle has driven fully or substantially over the road elevation and dazzling of the driver of the preceding vehicle is no longer an issue, this vision protection may be rolled up again. The same also applies for other types of devices to prevent dazzling of the driver of the preceding vehicle. This second actuation may be controlled time-dependently, i.e. after a predefined length of time has elapsed. It is also conceivable to carry out the second actuation when the sensors (for example a camera or a light-dependent sensor array) of the preceding vehicle have established that dazzling no longer applies. Likewise, it is conceivable to carry out the second actuation when a period of time that the following vehicle has required to drive over the road elevation from the start to the end has elapsed. This period of time may optionally be extended if, for example, it has been established that the following vehicle has reduced its speed, and the dazzling will therefore last longer.

According to a further embodiment, the length of time that the following vehicle requires to drive over the road elevation is ascertained to determine the instant for the deactivation of the device in the vehicle to prevent dazzling of the driver of the vehicle by the light source of the following vehicle and carry out the deactivation. In one embodiment, the actuated device in the vehicle to prevent dazzling of the driver of the vehicle may be deactivated after precisely the ascertained length of time. It is conceivable to extend the ascertained length of time by a time safety margin before the deactivation is carried out.

According to a further embodiment, the instant is ascertained from a distance between the preceding vehicle and the road elevation as well as a distance between the preceding vehicle and the following vehicle. The preceding vehicle uses its sensors to determine the distance from the road elevation and from the following vehicle. It is assumed that the distance between the preceding vehicle and the road elevation behind it is increasing. The distance between the two vehicles is then not to be regarded as constant but may vary dynamically, i.e. increase, decrease and remain the same. This change may be ascertained by the sensors of the preceding vehicle until the following vehicle arrives at the road elevation. Since at this moment the preceding vehicle knows its current distance from the road elevation behind it, over which it has already driven, as well as the current distance from the following vehicle, this is precisely the instant when the device in the vehicle to prevent dazzling of the driver of the vehicle by the light source of the following vehicle, when the latter drives over the road elevation, needs to be actuated. This instant may therefore be ascertained exactly by means of the sensors of the preceding vehicle and need not be estimated inaccurately, as is disadvantageously known from the prior art.

In a further embodiment, the distance between the preceding vehicle and the road elevation and/or the distance between the preceding vehicle and the following vehicle is ascertained continuously. Speed changes such as accelerations or decelerations of the preceding vehicle and/or of the following vehicle may therefore be considered when ascertaining the instant for actuating the device to prevent dazzling. This further increases the accuracy of the exact determination of the actuation instant.

In a further embodiment, an interior mirror of the vehicle is dimmed as the device in the vehicle to prevent dazzling of the driver of the vehicle. As an alternative or preferably in addition thereto, at least one exterior mirror of the vehicle is dimmed as the device in the vehicle to prevent dazzling of the driver of the vehicle. Since vehicles are often already equipped with dimmable mirrors, this equipment may be used optimally to implement the method according to the invention to prevent dazzling of the driver of a vehicle.

Likewise in addition or as an alternative thereto, according to a further embodiment, at least one mirror of the vehicle has its position in relation to the driver of the vehicle altered as the device in the vehicle to prevent dazzling of the driver of the vehicle. Such mirror adjustment devices are also often found in modern vehicles and may be used for the method according to the invention. Beginning with the position of the mirror that the driver has set, this position is altered at or preferably starting from the ascertained instant so that the headlamp beam from the following vehicle that reaches the preceding vehicle from behind is no longer reflected by the mirror into the field of view of the driver but instead is reflected so that it no longer dazzles the driver.

Besides using mirrors of the vehicle to implement the method according to the invention, other devices to prevent dazzling of the driver of the vehicle may be envisioned, for example a darkenable back window, unfoldable or unrollable vision protection in particular in the region of the back window of the preceding vehicle, and the like. Furthermore, the back window may also be rendered opaquer (for example by liquid crystals reflecting light incident in the interior and thus reducing dazzle effects). Alternatively, if the vehicle does not have a back window but only has a reversing camera, the photosensitivity of this reversing camera may be adapted (reduced). This list is not exhaustive and may include further corresponding devices.

### BRIEF DESCRIPTION OF THE DRAWINGS

Further advantageous embodiments of the invention are disclosed in the dependent claims and the following description of the figures, in which

FIG. 1 shows a vehicle on a road before a road elevation.

FIG. 2 shows the vehicle when driving over the road elevation.

FIG. 3 shows the vehicle after driving over the road elevation, behind which there is a following vehicle before the road elevation.

FIG. 4 shows the disadvantageous dazzling of the driver of the preceding vehicle when the following vehicle drives over the road elevation (prior art).

FIG. 5 shows the avoidance of the dazzling of the driver of the preceding vehicle according to the invention.

### DETAILED DESCRIPTION

In the various figures, parts which are the same are always provided with the same references, for which reason they will generally also be described only once.

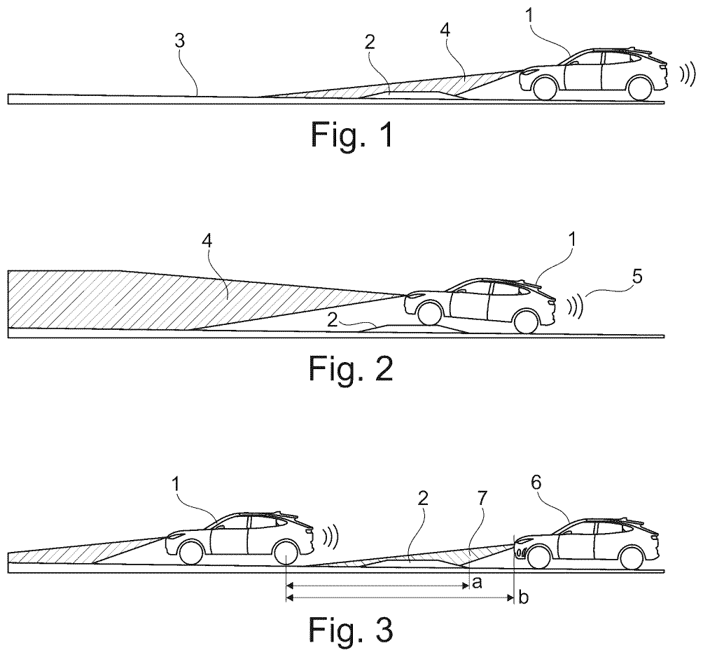

FIG. 1 shows a vehicle 1 on a road before a road elevation. The vehicle 1 is approaching a road elevation 2 that lies on a road 3 (for example a street). It is assumed that it is twilight or dark, so the vehicle 1 has switched on its low beam and is generating a headlamp beam 4 forward in the driving direction.

FIG. 2 shows the vehicle 1 when driving over the road elevation 2, so that the front of the vehicle 1 has been raised slightly because it is driving over the road elevation 2 and, as can be seen, a different orientation is therefore imparted to the headlamp beam upward in the plane of the drawing compared to its orientation that is represented in FIG. 1, and it thus shines further into the distance. FIG. 2 furthermore shows, as already indicated in FIG. 1, that the vehicle 1 has sensors, in particular sensors 5 that are arranged in the tail region of the vehicle 1 and/or can capture the region to the rear behind the vehicle 1.

FIG. 3 shows the vehicle 1 after driving over the road elevation 2, behind which there is a following vehicle 6 whose position lies before the road elevation 2. The following vehicle 6 has also switched on its lights because of the twilight or darkness and is generating its own headlamp beam 7. The orientation of this headlamp beam of the 7 has a regular orientation, like the headlamp beam 4 of the vehicle 1, this regular orientation being stipulated in practice.

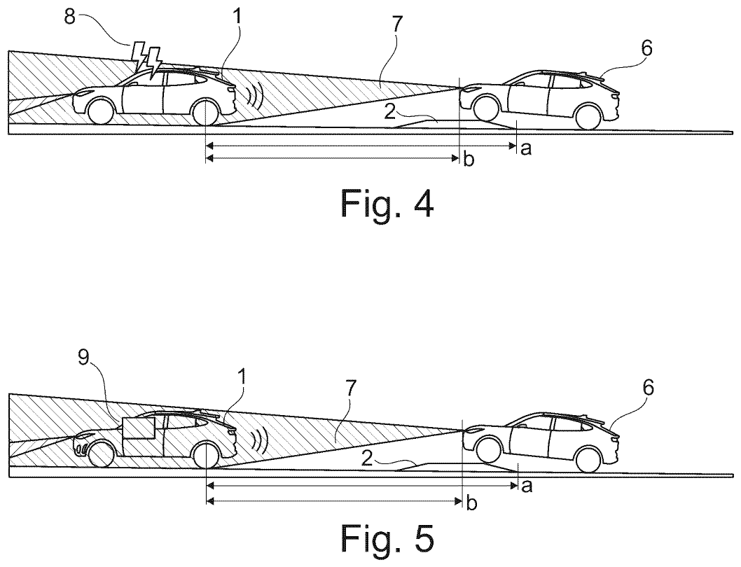

FIG. 4 shows the disadvantageous dazzling of the driver of the preceding vehicle 1 when the following vehicle 6 drives over the road elevation 2. By driving onto and over the road elevation 2, the front of the following vehicle 6 is raised so that an orientation which impinges on the rear side of the preceding vehicle 1, and therefore dazzles its driver, is imparted to its headlamp beam 7, in particular its low beam. The dazzling occurs above all because the headlamp beam 7 is deflected by the interior mirror and/or at least one of the exterior mirrors of the preceding vehicle 1 into its driver's face. This causes the dazzling already explained in the introduction and the concomitant impairments due to this dazzling, which is represented in FIG. 4 with the reference 8 in the form of two lightning bolts.

It is here that the invention takes effect. FIG. 5 shows the avoidance of the dazzling of the driver of the preceding driver 1 according to the invention. The vehicle 1 contains a device (not represented) to prevent dazzling of the driver of the vehicle 1 by the light source of the following vehicle 6 when the latter drives over the road elevation 2. This device is actuated when the sensors 5 of the preceding vehicle 1 have ascertained when the following vehicle 6 drives over the road elevation 2 and its headlamp beam 7 therefore becomes oriented toward the rear side of the preceding vehicle 1, which leads to dazzling of the driver of the vehicle 1 (as described below). In FIG. 5, the dazzling prevented by the device is provided with the reference 9 and is symbolically represented as a rectangle. This device may, for example, be a dimmable interior mirror and/or at least one dimmable exterior mirror and/or a darkenable back window or unfoldable or unrollable vision protection in the region of the back window of the vehicle 1, and the like. This device is actuated until the headlamp beam 7 of the following vehicle 6 no longer impinges on the tail of the preceding vehicle 1. This may, for example, be ascertained by means of the sensors 5 of the vehicle 1. As an alternative or in addition thereto, it is conceivable that this device is actuated for a predefined time. Likewise as an alternative or in addition thereto, the time for the actuation of this device may, for example, be precisely the time that the vehicle 1 has required to drive over the road elevation 2 from the start to the end, or slightly longer. This may also be ascertained, for example, with the sensors 5 of the vehicle 1.

Studying FIGS. 3 and 5 clarifies the way in which the instant is ascertained from a distance a between the preceding vehicle 1 and the road elevation 2 (which by now it has already driven over and which therefore lies to the rear) as well as from a distance b between the preceding vehicle 1 and the following vehicle 6. The preceding vehicle 1 uses its sensors 5 to ascertain the distance a from the road elevation 2 and from the following vehicle 6, after it has driven over the road elevation 2. It is assumed that both distances a, b vary, for example increase (see the distance change when comparing FIGS. 3 and 5) because of the forward movement of the two vehicles 1, 6, and can be ascertained with the sensors 5 of the preceding vehicle 1, until the following vehicle 6 has also arrived at the road elevation 2. Since at this moment the preceding vehicle 1 has used its sensors 5 to ascertain its current distance a from the road elevation 2 behind it, over which it has already driven, as well as the current distance b from the following vehicle 6, this is precisely the instant when the device in the vehicle 1 to prevent dazzling of the driver of the vehicle 1 by the light source (headlamp beam 7) of the following vehicle 6, when the latter drives over the road elevation 2, needs to be actuated. This instant is therefore ascertained exactly by means of the sensors 5 (for example radar, laser, LIDAR and comparable suitable instruments) of the preceding vehicle 1.

1. A method, comprising:
ascertaining a road elevation by environmental sensors of a first vehicle;
ascertaining an instant when a second vehicle that is following the first vehicle and has a light source drives onto the road elevation; and
actuating a device in the first vehicle to prevent dazzling of a driver of the first vehicle by the light source of the following second vehicle when the second vehicle drives over the road elevation.

2. The method according to claim 1, wherein the following second vehicle has driven over the road elevation, the device in the first vehicle is deactivated by a second actuation.

3. The method according to claim 1, wherein a length of time that the following second vehicle requires to drive over the road elevation is ascertained.

4. The method according to claim 3, wherein the actuated device in the first vehicle to prevent dazzling of the driver of the first vehicle is deactivated after the length of time.

5. The method according to claim 3, wherein the instant for the actuation of the device in the first vehicle to prevent dazzling of the driver of the first vehicle is ascertained from a first distance between the preceding first vehicle and the road elevation and a second distance between the preceding first vehicle and the following second vehicle.

6. The method according to claim 5, wherein the first distance and the second distance are ascertained continuously.

7. The method according to claim 5, wherein an interior mirror of the first vehicle is dimmed as the actuation of the device in the first vehicle to prevent dazzling of the driver of the first vehicle.

8. The method according to claim 5, wherein at least one exterior mirror of the first vehicle is dimmed as the actuation of the device in the first vehicle to prevent dazzling of the driver of the first vehicle.

9. The method according to claim 5, wherein at least one mirror of the first vehicle has its position in relation to the driver of the first vehicle altered as the actuation of the device in the first vehicle to prevent dazzling of the driver of the first vehicle.

10. A method for preventing dazzling of a driver of a first vehicle after a road elevation, the method comprising:
detecting a road elevation using environmental sensors;
determining when a second vehicle with a light source activated that is following the first vehicle drives onto the road elevation; and
actuating a device of the first vehicle to prevent dazzling of the driver by the light source of the following second vehicle when the following second vehicle drives over the road elevation.

11. The method according to claim 10, wherein the detecting comprises using at least one of radar sensors, laser sensors, LIDAR sensors, or camera sensors of the first vehicle.

12. The method according to claim 10, further comprising continuously monitoring distances between the first vehicle and the road elevation and between the first vehicle and the following second vehicle.

13. The method according to claim 10, wherein the actuating comprises dimming an interior mirror of the first vehicle.

14. The method according to claim 10, wherein the actuating comprises dimming at least one exterior mirror of the first vehicle.

15. The method according to claim 10, wherein the actuating comprises adjusting mirror positions to redirect light away from the driver's field of view in the first vehicle.

16. The method according to claim 10, wherein the actuating comprises darkening a rear window or deploying vision protection in a region of the rear window of the first vehicle.

17. The method according to claim 10, further comprising deactivating the device after determining that the following second vehicle has completed passage over the road elevation.

18. The method according to claim 10, further comprising calculating a time duration for maintaining activation of the device based on a speed of the following second vehicle.
